(19) United States
(12) Patent Application Publication
(10) Pub. No.: US 2026/0065544 A1
(43) Pub. Date: Mar. 5, 2026

(54) VIDEO CONTENT TO SLIDE GENERATION

(71) Applicant: OPEN TEXT INC., Wilmington, DE (US)

(72) Inventor: Venkata Naga Sudhakar Vankamamidi, Hyderabad (IN)

(73) Assignee: OPEN TEXT INC., Wilmington, DE (US)

(21) Appl. No.: 18/817,675

(22) Filed: Aug. 28, 2024

(51) Int. Cl. G06T 11/60; G06F 40/166; G06V 10/74; G06V 10/774; G06V 10/82; G06V 20/40; G06V 40/10

(52) U.S. Cl. CPC G06T 11/60; G06F 40/166; G06V 10/761; G06V 10/774; G06V 10/82; G06V 20/49; G06T 2210/12; G06V 40/10

(57) ABSTRACT

Presentations are often broadcast or video recorded without handouts, such as the slides presented by a presenter of the presentation. Without handouts it is difficult and resource intensive to identify a particular slide of interest. Systems and methods are provided to automatically convert frames of a presentation video (e.g., a file or broadcast) to images in a document (e.g., Word™, PDF, etc.). Frames of the presentation are included in the document unless excluded. The frames are excluded when determined to be duplicative of a previous frame. Frames are duplicative if they are determined to be identical or nearly identical when hashed via an image hashing function. A non-identical frame is further determined to be duplicative when not identical to a previous frame but the differences are limited to only irrelevant visual content (e.g., the presenter gesturing).

### FIELD OF THE DISCLOSURE

The invention relates generally to systems and methods for the intelligent capturing of still images from an audio-video source and particularly to machine-based content selection to produce still images.

### BACKGROUND

Presentations are often recorded for later viewing. Presentations are highly variable in terms of their content. For example, one presentation may comprise a presenter speaking with few, if any, visual elements (e.g., slides, videos, demonstrations, etc.). Other presentations may be entirely composed of visual elements.

Presentations routinely include handouts, such as copies of the slides, notes, or syllabi. However, handouts are not consistently made available, and even when they are, they may be misplaced or discarded. As a result, the user may need to rely on accessing a stored recording of the presentation for reviewing content, hopefully locating the portion of interest.

### SUMMARY

A user may wish to view a select portion, such as a topic, of a previously recorded video. The user may not have the benefit of handouts or other guides to direct their review to a particular portion of the video. Often a user may not wish to view the entire video but instead jump to a particular topic of interest and terminate the viewing after the video's discussion of the topic of interest is over. Unfortunately, jumping to a particular topic is often difficult as the user may not know where the topic of interest is in the video or even the duration of the discussion on that topic.

For example, if a video of a presentation has a duration of one hour, and the topic of interest is twenty minutes long, then it would be relatively easy for a user to identify the topic of interest by random chance, assuming the user knows the presentation comprises a relatively large portion of the topic of interest. However, if the hour-long recording only discussed the topic of interest for a few minutes or less, locating the topic of interest becomes more challenging.

As a result, a user may randomly jump to points in the video, view visual elements (if any), and listen to the discussion. Often this only reveals a different topic is being addressed without knowing if the topic of interest is earlier or later in the video. The user then randomly jumps to another point in the video hoping to find the topic of interest. These attempts to locate the topic of interest may be time consuming and resource intensive and may even be unsuccessful. The user may waste time and resources randomly picking locations, viewing portions of the video, and randomly picking another location which, if unsuccessful, may cause the user to give up and restart the video from the beginning. The user may be able to fast-forward through portions or watch the presentation with accelerated playback in the hope of wasting less time finding the topic of interest. However, the more a user jumps ahead or accelerates the playback, the user's attentiveness will likely suffer, resulting in more re-starts and often requiring the user to watch the entire video at normal or minimally accelerated playback until the topic of interest is located and consumed (e.g., viewed or listened to).

In addition to the inconvenience, computing resources must be allocated to play back the video, potentially necessitating multiple sessions. Video files are often stored on one device and buffered to another storage device to reduce lag during playback. The video may be buffered to memory and further consume computer storage. As a result, storage of the video and copies that automated systems and users may create (e.g., download to a local device) for their own use or playback may result in waste additional memory, storage, and often networking resources, particularly when only a portion of the video is of interest. For example, a user may wish to refer back to a few minutes of a presentation several times, which may span a single viewing session or many years. In order to enable viewing, the video is maintained, in its entirety, on a storage device that may be otherwise allocated for other purposes. Processing resources are required to manage the playback, such as to decode a video file at a given location and buffer and stream the video. If the user then jumps to another portion, the content in the buffer is flushed or overwritten and the process continues while allocating computing, storage, and networking resources unnecessarily.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are provided to identify and take unique screenshots from a video, which may include live video. Duplicate screenshots are omitted, and the resulting screenshots are collated for viewing, such as into a portable document format (PDF), Word™, or other document format. As a benefit, a user can quickly and easily scan the document and identify the content of interest.

In some aspects, the techniques described herein relate to a method for compressing a video presentation, including: capturing a first still image from a first frame of the video presentation; writing the first still image to a document; capturing a second still image from a second frame of the video presentation; comparing the first still image to the second still image to determine whether the difference is greater than a threshold; and when the difference is greater than the threshold, writing the second still image to the document and when the difference is not greater than the threshold, omitting writing the second still image to the document.

In some aspects, the techniques described herein relate to a method, wherein comparing the first still image to the second still image includes: applying a first mask to mask the first frame to exclude a first human subject image to produce a masked first still image; and applying a second mask to the second frame to exclude a second human subject image to produce a masked second still image; and wherein comparing the first still image to the second still image to determine if the difference is greater than the threshold includes comparing the masked first still image to the masked second still image to determine whether the difference between the first masked image and the second masked image is greater than the threshold.

In some aspects, the techniques described herein relate to a method, further including: upon determining the ratio of the second mask to the second still image is greater than a mask threshold, determining the difference between the masked first still image and the masked second still image is not greater than the threshold.

In some aspects, the techniques described herein relate to a method, wherein: applying the first mask to mask the first frame to exclude the first human subject image to produce a masked first still image further includes applying the first mask to a first rectangle selected to minimally include the first human subject image and wherein the first rectangle is at a first location within the first frame; and applying the second mask to mask the second frame to exclude the second human subject image to produce the masked second still image further includes applying the second mask to a second rectangle selected to minimally include the second human subject image and wherein the second rectangle is at a second location within the first frame.

In some aspects, the techniques described herein relate to a method, further including: calculating a first image hash of the first still image; and calculating a second image hash of the second still image; and wherein comparing the first still image to the second still image to determine whether the difference is greater than the threshold includes comparing the first image hash to the second image hash to determine whether the difference is greater than the threshold.

In some aspects, the techniques described herein relate to a method, wherein calculating the first image hash of the first still image and calculating the second image hash of the second still image each include calculating the hash further determined from at least one of image average analysis, perceptual analysis, difference analysis or wavelet analysis on structures within each of the first still image and the second still image.

In some aspects, the techniques described herein relate to a method, further including: creating a first grayscale image of the first still image; and creating a second grayscale image of the second still image; and wherein comparing the first still image to the second still image to determine whether the difference is greater than the threshold includes comparing the first grayscale image to the second grayscale image to determine whether the difference is greater than the threshold.

In some aspects, the techniques described herein relate to a method, wherein the first still image and the second still image are separated by at least one intervening frame of the video presentation.

In some aspects, the techniques described herein relate to a method, wherein: comparing the first still image to the second still image to determine whether the difference is greater than the threshold further includes determining a relevant portion of the first still image and a relevant portion of the second still image; further comparing the relevant portion of the first still image to the relevant portion of the second still image to determine whether the difference is greater than the threshold; determining the relevant portion of the first still image includes providing the first still image to a neural network trained to identify relevant portions of images and receiving a decision therefrom; and comparing the first still image to the second still image to determine whether the difference is greater than the threshold includes comparing portions of the first still image identified as relevant by the neural network to portions of the second still image identified as relevant by the neural network.

In some aspects, the techniques described herein relate to a method, wherein the neural network is trained including: collecting a set of prior still images from a database, the prior set of still images including relevant portions; applying one or more transformations to each prior still image, including adding a video effect, removing a video effect, adjusting the brightness, adjusting the contrast, inserting a known non-relevant element, removing a known non-relevant element, inserting a known relevant element, removing a known non-relevant element, shifting the location of an element in the image, and resizing an element in the image, to create a modified set of prior still images; creating a first training set including the collected set of prior still images, the modified set of prior still images, and a set of prior still images without a relevant portion; training the neural network in a first stage using the first training set; creating a second training set for a second stage of training including the first training set and the set of prior still images without a relevant portion incorrectly determined as including relevant portions after the first stage of training; and training the neural network in the second stage using the second training set.

In some aspects, the techniques described herein relate to a system for compressing a video presentation, including: at processor coupled to a computer memory including computer-readable instructions to cause the processor to: capture a first still image from a first frame of the video presentation; write the first still image to a document; capture a second still image from a second frame of the video presentation; compare the first still image to the second still image to determine whether the difference is greater than a threshold; when the difference is greater than the threshold, write the second still image to the document and when the difference is not greater than the threshold, omit writing the second still image to the document; and cause a data storage component to store the document.

In some aspects, the techniques described herein relate to a system, wherein the instructions to cause the processor to compare the first still image to the second still image includes instructions to cause the processor to: apply a first mask to mask the first frame to exclude a first human subject image to produce a masked first still image; and apply a second mask to the second frame to exclude a second human subject image to produce a masked second still image; and wherein comparing the first still image to the second still image to determine if the difference is greater than the threshold includes comparing the masked first still image to the masked second still image to determine whether the difference between the first masked image and the second masked image is greater than the threshold.

In some aspects, the techniques described herein relate to a system, further including instructions to cause the processor to, upon determining the ratio of the second mask to the second still image is greater than a mask threshold, determine the difference between the masked first still image and the masked second still image is not greater than the threshold.

In some aspects, the techniques described herein relate to a system, wherein: applying the first mask to mask the first frame to exclude the first human subject image to produce the masked first still image further includes applying the first mask to a first rectangle selected to minimally include the first human subject image and wherein the first rectangle is at a first location within the first frame; and applying the second mask to mask the second frame to exclude the second human subject image to produce the masked second still image further includes applying the second mask to a second rectangle selected to minimally include the second human subject image and wherein the second rectangle is at a second location within the first frame.

In some aspects, the techniques described herein relate to a system, further including instructions to cause the processor to: calculate a first image hash of the first still image; and calculate a second image hash of the second still image; and wherein comparing the first still image to the second still image to determine whether the difference is greater than the threshold includes comparing the first image hash to the second image hash to determine whether the difference is greater than the threshold.

In some aspects, the techniques described herein relate to a system, wherein calculating the first image hash of the first still image and calculating the second image hash of the second still image each include a hashing calculation further determined from at least one of image average analysis, perceptual analysis, difference analysis, or wavelet analysis on structures within each of the first still image and the second still image.

In some aspects, the techniques described herein relate to a system, further including instructions to cause the processor to: create a first grayscale image of the first still image; and create a second grayscale image of the second still image; and wherein comparing the first still image to the second still image to determine whether the difference is greater than the threshold includes comparing the first grayscale image to the second grayscale image to determine whether the difference is greater than the threshold.

In some aspects, the techniques described herein relate to a system, wherein: instructions to cause the processor to compare the first still image to the second still image to determine whether the difference is greater than the threshold further include instructions to cause the processor to determine a relevant portion of the first still image and a relevant portion of the second still image; the instructions further cause the processor to compare the relevant portion of the first still image to the relevant portion of the second still image to determine whether the difference is greater than the threshold; the instructions further cause the processor to determine the relevant portion of the first still image include providing the first still image to a neural network trained to identify relevant portions of images and receive a decision therefrom; and the instructions to cause the processor to compare the first still image to the second still image to determine whether the difference is greater than the threshold includes instructions to cause the processor to compare portions of the first still image identified as relevant by the neural network to portions of the second still image identified as relevant by the neural network.

In some aspects, the techniques described herein relate to a system, wherein the neural network is trained including: collecting a set of prior still images from a database, the prior still images including relevant portions; applying one or more transformations to each prior still image, including adding a video effect, removing a video effect, adjusting the brightness, adjusting the contrast, inserting a known non-relevant element, removing a known non-relevant element, inserting a known relevant element, removing a known non-relevant element, shifting the location of an element in the image, and resizing an element in the image, to create a modified set of prior still images; creating a first training set including the collected set of prior still images, the modified set of prior still images, and a set of prior still images without a relevant portion; training the neural network in a first stage using the first training set; creating a second training set for a second stage of training including the first training set and the set of prior still images without a relevant portion incorrectly determined as including relevant portions after the first stage of training; and training the neural network in the second stage using the second training set.

In some aspects, the techniques described herein relate to a non-transitory computer-readable medium including instructions that, when read by a machine, cause the machine to perform: capturing a first still image from a first frame of a video presentation; capturing a second still image from a second frame of the video presentation; comparing the first still image to the second still image to determine whether the difference is greater than a threshold; and when the difference is greater than the threshold, writing the second still image to a document, and when the difference is not greater than the threshold, omit writing the second still image to the document.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts a frame in accordance with embodiments of the present disclosure;

FIGS. 4A-4C depict frames in accordance with embodiments of the present disclosure;

FIG. 5 depicts a process in accordance with embodiments of the present disclosure; and

FIG. 6 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

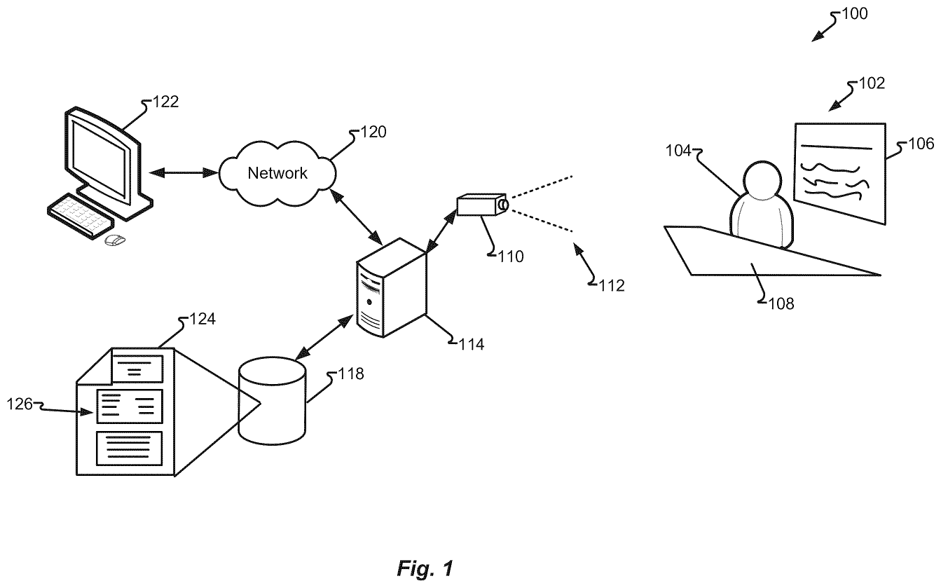

FIG. 1 depicts system 100 in accordance with embodiments of the present disclosure. In one embodiment, system 100 illustrates components, and their relationship to other components, utilized for capturing and broadcasting, and optionally recording, a live broadcast of a presentation. It should be appreciated that presentations are utilized herein as one embodiment, but without limitation, such as to include lectures, performances, conferences, demonstrations, and the like. Also, one of ordinary skill in the art will recognize that the illustrated topology formed by the components may be modified without departing from the scope of the embodiments herein. For example, certain components may be embodied as a plurality of components and/or two or more components may be embodied as a single component. In one embodiment, the components as illustrated perform a single function and, in other embodiments, one or more components may perform a plurality of functions and/or one or more functions may be performed by a plurality of components including as a service (e.g., software as a service (SaaS)). Similarly, the topology illustrated includes two components, each having a connection to network 120. One of ordinary skill will also recognize that other network connections, such as additional components being individually connected to network 120 and/or network 120 comprising two or more networks (e.g., a local area network (LAN), wide area network (WAN), cellular network, Wi-Fi network, etc.) may be utilized. In yet another embodiment, multiple components, individually, may perform the function of a single component but at different times. For example, first server 114 may encode video signals for storage of a recording maintained in database 118, whereas a second server 114 may access the recording. Server 114 may access the recording maintained on a first database 118 or the recording may be moved or copied to a second database 118 for access and playback by server 114.

In one embodiment, system 100 includes camera 110 having field of view 112. Camera 110 captures scene 102, such as a presentation by presenter 104 with visual elements 106, such as may be presented physically (e.g., via a whiteboard, flip chart, video display, etc.). It should be appreciated that visual elements 106 may be presented and included in the presentation electronically (e.g., via screen sharing, a slide viewer portion of a presentation application, etc.). Scene 102 may include irrelevant or unwanted portions, such as table 108 or other elements (e.g., walls, furniture, audience members, other presenters, etc.).

Server 114 is provided with the encoded video from camera 110. Server 114 may similarly be provided with sound captured by a microphone (not shown) or slides or other visuals inserted into the presentation electronically. Server 114 may then cause a recording of the presentation to be stored to database 118 and/or broadcast via network 120 to device 122, which may be one or more devices. Server 114 may perform other presentation services (e.g., floor control, agenda management, automatic muting, bandwidth management, authenticating users, etc.).

Device 122 may be viewing (and listening) to the presentation in real-time (e.g., as it happens, less the time required to encode, broadcast, and decode the presentation) or delayed (e.g., buffered). In other embodiments, device 122 may view the presentation as recorded and maintained on database 118 (or another data storage device, such as a storage device of device 122).

In another embodiment, a user of device 122 may access specific information (i.e., some but less than all) from the presentation, such as a slide presented during the presentation. Accordingly, a component, such as server 114 and/or device 122, generates document 124 comprising unique slides images captured from the presentation (whether live or recorded). As will be described more completely with respect to the embodiments below, document 124 comprises slide images 126 of relevant content (e.g., slides) and omits content that is not relevant (e.g., presenter 104, duplicate of a previous still image, etc.). As a benefit, a user of device 122 may retrieve document 124 for review.

Once document 124 is created, the video file maintained on database 118 may be deleted or, if kept, moved to a data storage allocated for seldom accessed information. Additionally, document 124 may be shared among a number of users, thereby avoiding the need for subsequent users to create their own version of document 124 or retrieve and view the stored video file. For example, a presentation that is years old may have little, but some, topics of interest. Storing, streaming/downloading, and viewing the old presentation unnecessarily wastes system and human resources when only a small portion of the content is relevant. Similarly, an organization may have an archive of old presentations, which may comprise a large number of video files. However, it is rare that system and human resources will be allocated to view old presentations absent an overwhelming need, even if there is valuable content somewhere in the collection of old videos. By automatically creating document 124 for each of the old presentations, their content can be quickly determined and replaced or supplemented by their corresponding document 124. The presentations' source video files may then be moved to offline storage or discarded entirely.

Presentations may not have handouts or other documentation of the content presented. If handouts are provided, they can be misplaced or become disassociated with their corresponding video file of the presentation. Viewing a presentation requires one or more processors of one or more devices (e.g., server 114, database 118, device 122, and various networking components of network 120) to access, encode, transmit, receive, decode, and present the presentation. Such a processing demand is greatly reduced by creating document 124 comprising slide images 126 of the presentation.

Document 124 may be generated by device 122, such as by one or more processors of device 122 executing a client application, server 114, such as by one or more processors of server 114 executing a server-side application, and/or another device (e.g., “cloud” processor). Document 124 may be stored on database 118, a storage device or memory of device 122, and/or other devices, as well as printed or transmitted (e.g., downloaded, streamed, emailed, posted, etc.). When document 124 is created by device 122, device 122 may access a recording of the video file (whether a live stream or stored video file) and analyze the frames of the video for the creation of a slide image of the slide images 126. In another embodiment, device 122 may execute an application that accesses the frames as presented on a portion of a display of device 122 by examining values in a memory, such as a video buffer, utilized to display the presentation.

Document 124 may comprise a number of slide images 126 of the slides and/or other relevant content presented during the presentation and captured in a video file (e.g., MP4, AVI, etc.). Document 124 provides visual representations of the presentation (slide images 126) that allow a user to quickly identify topics of interest and/or identify those topics that are not of interest as compared to viewing the video. As a further option, slide images 126 may be processed by an optical character reader (OCR) to enable textual searching.

As will be discussed more completely with respect to the embodiments below, slide images 126 omit frames captured from a presentation that duplicate a previous frame and/or are limited to irrelevant visual content. For example, a presenter (human) captured in a frame of a video may be determined to be irrelevant when the frame comprises the presenter alone (i.e., the presentation is absent slides or relevant text, images, graphics, etc.) and is then omitted from slide images 126. Similarly, if two frames have the same or substantially the same visual information, only one slide image 126 is generated. Additionally or alternatively, two or more frames may be the same or substantially the same, but not adjacent, and frames may be removed from slide images 126, such as when non-adjacent but similar frames may be encountered when presenter 104 goes back to a previously presented slide.

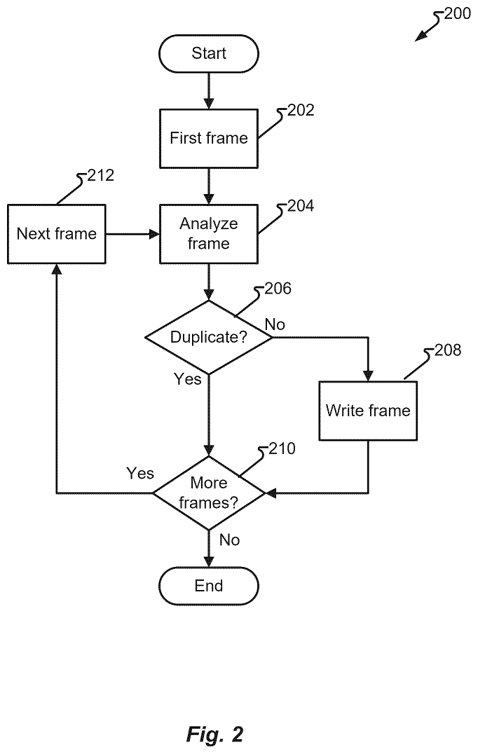

FIG. 2 depicts process 200 in accordance with embodiments of the present disclosure. In one embodiment, process 200 is embodied as machine-readable instructions maintained in a non-transitory memory that when read by a machine, such as one or more processors of a server or servers, cause the machine to execute the instructions and thereby execute process 200. The processor may include, but is not limited to, at least one processor of server 114 and/or at least one processor of device 122.

Process 200 begins and, at step 202, a first frame of a video file is accessed. Accessing the video file may comprise accessing a live video feed or retrieving frames from a previously recorded video file. As used herein, the term “frame” refers to a time-slice of a video (e.g., the digital equivalent of a single image captured on a movie film) rather than a border, boundary, or area of a video image. Step 204 analyzes the frame to extract indicators of the visual elements imaged within the frame and the content therein.

Test 206 determines if the frame is a duplicate of the previous frame. In one embodiment, test 206, when applied to the first frame, is determined in the negative without regard to the absent previous frame. Test 206 is determined in the affirmative if the frame and the previous frame are identical and no further processing is required, and processing then continues to test 210.

Frames of a presentation will often include identical content (e.g., objects and information imaged) but not be identical images. For example, the difference between two frames may be a gesture of presenter 104, movement by audience members in the foreground, or presenter 104 walking across a stage with either the image of presenter 104 remaining stationary (i.e., camera 110 pans to follow presenter 104) or the image of presenter 104 moving within the frame. When two frames have image differences that are limited to differences in irrelevant content, test 206 is determined in the affirmative. However, if there remain differences in the visual content, test 206 is determined in the negative and processing continues to step 208 wherein the frame is written to a document, such as to generate a slide image of the slide images 126 in document 124. Test 210 determines if there are more frames and, if determined in the negative, process 200 ends. If test 210 is determined in the affirmative, step 212 accesses the next frame and processing loops back to step 204.

Returning to step 204, determining whether the differences between a frame and the preceding frame are limited to differences in irrelevant content, and thereby excluded from document 124 (i.e., test 206 is determined in the affirmative), or if the differences extend to content determined to be relevant (or non-irrelevant), and to be included in document 124 (i.e., test 206 is determined in the negative) is variously embodied. Irrelevant content may be masked or otherwise excluded from further consideration and, when relevant content remains, the frame to be written to document 124 as one of the slide of slide images 126 in step 208. In another embodiment, only a portion (i.e., of the relevant content) is written to document 124 as one of the slide of slide images 126.

In one embodiment, two frames are provided to a neural network trained to determine whether there are relevant differences and receive a decision therefrom.

In another embodiment, two frames are processed by an image hashing algorithm to determine a similarity score therebetween. If the similarity score is greater than a threshold value, the frames have images that are substantially similar and may be considered irrelevant. The hashing algorithm, such as the “Image Hash” algorithm identified above, converts the images to grayscale, reduces the size of the images, averages the colors, computes bits by comparing color values that are either above or below a mean, and hashes the result.

In another embodiment, if the difference between two frames is limited to the different attributes of a human body (e.g., presenter 104), the difference is determined to be irrelevant. For example, a human may gesture, walk, stand up, sit down, change expressions, etc., which are then considered irrelevant.

In another embodiment, an image that comprises an image of a human that exceeds a predetermined threshold or ratio is irrelevant content. For example, a frame with an image of a human is overlayed (on a display or in computer memory) with a bounding box to narrowly include the human. If the ratio of the number of pixels within the box to the number of pixels of the frame is greater than a threshold value, such as 8%, then the frame may be considered to comprise a human and, therefore, is identified as irrelevant.

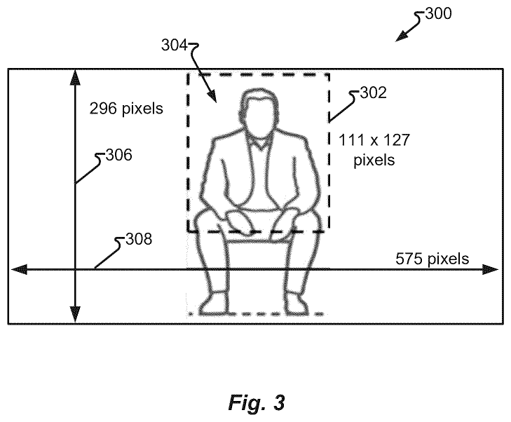

FIG. 3 depicts frame 300 in accordance with embodiments of the present disclosure. Frame 300 has width 308 (575 pixels) and height 306 (296 pixels), having a total of 170,200 pixels. Bounding box 302 overlays human image 304 or a portion thereof (e.g., a bottom portion of frame 300 and/or human image 304 may be masked as irrelevant). Bounding box 302 has dimensions (111×127 pixels) and encompasses 14,097 pixels. The ratio of total pixels (170,200) to bounding box 302 pixels (14,097) is ˜8.2%. If the ratio is greater than a threshold (i.e., a sufficiently large ratio of the frame pixels are images of the human), bounding box 302 is masked and excluded from further processing.

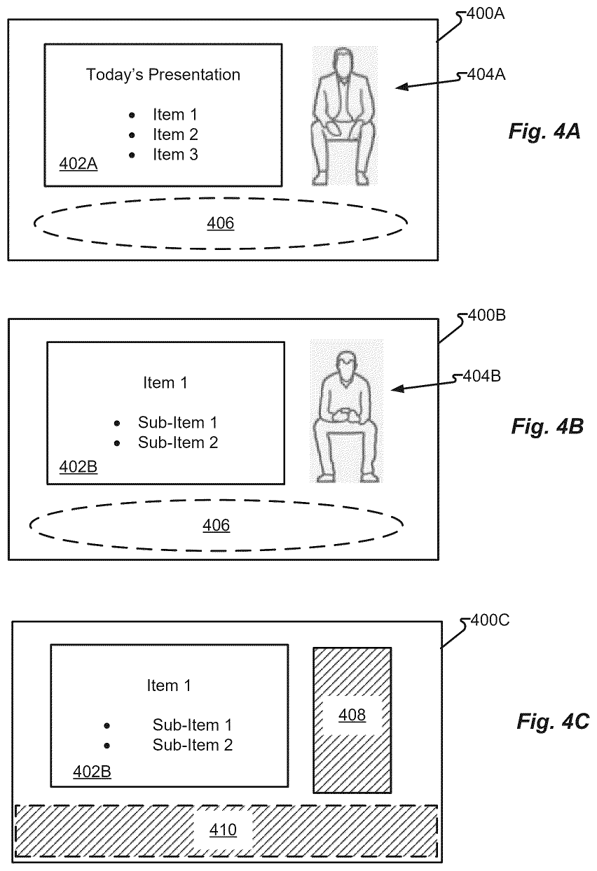

FIGS. 4A-4C depict frames 400A-400C in accordance with embodiments of the present disclosure. Frame 400A is one frame of a presentation comprising presenter 404A in a first pose, first slide 402A, and foreground 406 (e.g., audience members, table, desk, etc.). Frame 400B illustrates presenter 404B in a second pose, second slide 402B, and foreground 406. Differences are determined between frames 400A and 400B.

In one embodiment, presenter 404A in a first pose and presenter 404B in a second pose are overlayed by mask 408 and excluded. Mask 408 may be determined, in whole or in part, by identifying presenter 404A and/or 404B as a human and, therefore, irrelevant. Similarly, foreground 406 may comprise static objects (e.g., a floor, table, stage, etc.) and, therefore, may be excluded. Frames that are, or comprise, the same visual content are duplicative and, absent other visual content that is not duplicative, are excluded from being written to document 124. However, if differences between frame 400A and frame 400B are determined to exist but are determined to be irrelevant, such as by a neural network (e.g., audience members moving in foreground 406), then the differences are similarly determined to be irrelevant. Irrelevant dynamic portions of frame 400A and/or frame 400B may be masked by mask 410 and excluded from further processing.

Frame 400B also comprises differences from frame 400A (a previous frame) in that the slides being presented have changed from slide 402A to slide 402B. As the change is outside of all masked areas (e.g., mask 408, mask 410), the difference is determined relevant (or not irrelevant) and frame 400B is written to document 124.

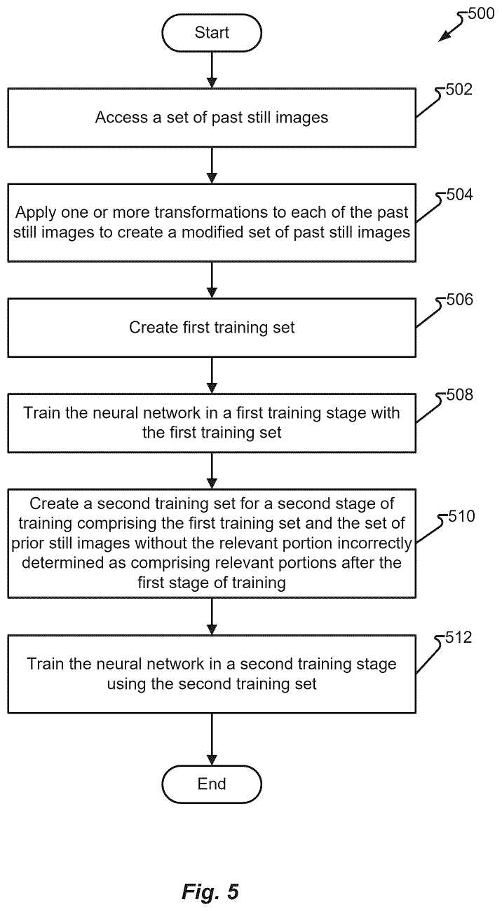

FIG. 5 depicts process 500 in accordance with embodiments of the present disclosure. In one embodiment, process 500 is embodied as machine-readable instructions maintained in a non-transitory memory that when read by a machine, such as one or more processors of a server or servers, cause the machine to execute the instructions and thereby execute process 500. The processor may include, but is not limited to, at least one processor of server 114 and/or at least one processor of device 122.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., a hyperplane) to delineate a combination of inputs that are active or inactive.

Process 500 begins and, in step 502, a set of prior still images are collected or accessed, such as from a database, the prior still images comprising relevant portions. Optionally, step 502 may include collecting a set of prior still images comprising irrelevant portions. Step 504 applies one or more transformations to each prior still image, including adding a video effect (e.g., fly-in, grow, rotate, blur-in, scene wipe, etc.), removing a video effect, adjusting the brightness, adjusting the contrast, inserting a known non-relevant element, removing a known non-relevant element, inserting a known relevant element, removing a known non-relevant element, shifting the location of an element in the image, and resizing an element in the image, to create a modified set of prior still images. Step 506 creates a first training set comprising the collected set of prior still images, the modified set of prior still images, and a set of prior still images without a relevant portion.

Step 508 trains the neural network in a first training stage using the first training set. Step 510 creates a second training set for a second stage of training comprising the first training set and the set of prior still images without a relevant portion incorrectly determined as comprising relevant portions after the first stage of training. Step 512 trains the neural network in the second training stage using the second training set.

Once trained, the neural network is provided with a frame and responds with a determination of whether or not the image comprises any relevant content. If relevant content is determined to be present, the frame may be compared to a previous frame and, if non-similar, written to a document.

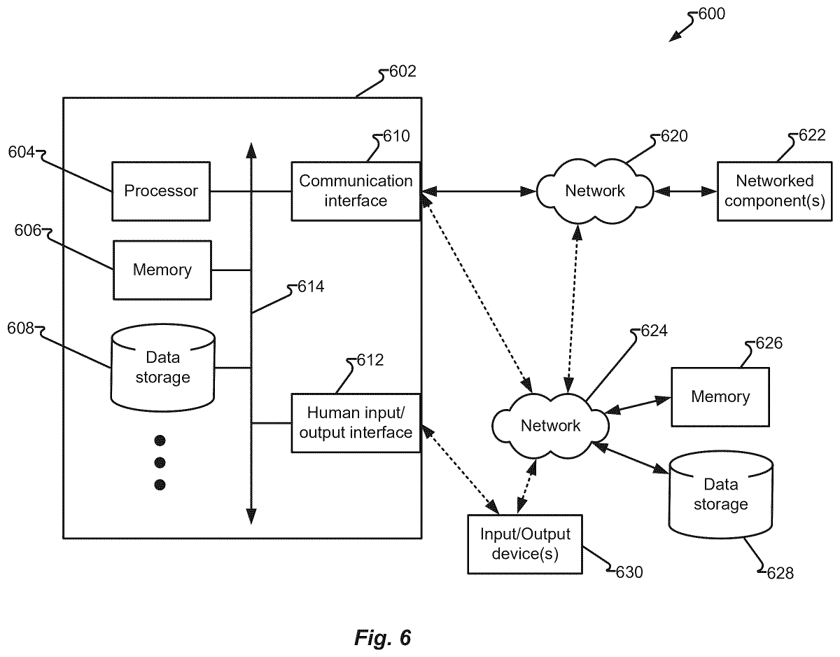

FIG. 6 depicts system 600 in accordance with embodiments of the present disclosure. In one embodiment, server 114 and/or device 122 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise programmable logic functionality, such as determined, at least in part, from accessing machine-readable instructions maintained in a non-transitory data storage, which may be embodied as circuitry, on-chip read-only memory, computer memory 606, data storage 608, etc., that cause the processor 604 to perform the steps of the instructions. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize computer memory 606 and/or data storage 608 for the storage of accessible data, such as instructions, values, etc. Communication interface 610 facilitates communication with components, such as processor 604 via bus 614 with components not accessible via bus 614 and may be embodied as a network interface (e.g., ethernet card, wireless networking components, USB port, etc.). Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or configured to utilize one or more networks, such as network 620 and/or network 624.

Network 120 may be embodied, in whole or in part, as network 620. Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) than networked components 622, which may be connected to network 620 comprising a public network (e.g., Internet) that may not be as trusted.

Components attached to network 624 may include computer memory 626, data storage 628, input/output device(s) 630, and/or other components that may be accessible to processor 604. For example, computer memory 626 and/or data storage 628 may supplement or supplant computer memory 606 and/or data storage 608 entirely or for a particular task or purpose. As another example, computer memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of computer memory 606, data storage 608, computer memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, a switch, a port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for compressing a video presentation, comprising:
capturing a first still image from a first frame of the video presentation;
writing the first still image to a document;
capturing a second still image from a second frame of the video presentation;
comparing the first still image to the second still image to determine whether the difference is greater than a threshold; and
when the difference is greater than the threshold, writing the second still image to the document and when the difference is not greater than the threshold, omitting writing the second still image to the document.

2. The method of claim 1, wherein comparing the first still image to the second still image comprises:
applying a first mask to mask the first frame to exclude a first human subject image to produce a masked first still image; and
applying a second mask to the second frame to exclude a second human subject image to produce a masked second still image; and
wherein comparing the first still image to the second still image to determine if the difference is greater than the threshold comprises comparing the masked first still image to the masked second still image to determine whether the difference between the first masked image and the second masked image is greater than the threshold.

3. The method of claim 2, further comprising:
upon determining the ratio of the second mask to the second still image is greater than a mask threshold, determining the difference between the masked first still image and the masked second still image is not greater than the threshold.

4. The method of claim 2, wherein:
applying the first mask to mask the first frame to exclude the first human subject image to produce a masked first still image further comprises applying the first mask to a first rectangle selected to minimally include the first human subject image and wherein the first rectangle is at a first location within the first frame; and
applying the second mask to mask the second frame to exclude the second human subject image to produce the masked second still image further comprises applying the second mask to a second rectangle selected to minimally include the second human subject image and wherein the second rectangle is at a second location within the first frame.

5. The method of claim 1, further comprising:
calculating a first image hash of the first still image; and
calculating a second image hash of the second still image; and
wherein comparing the first still image to the second still image to determine whether the difference is greater than the threshold comprises comparing the first image hash to the second image hash to determine whether the difference is greater than the threshold.

6. The method of claim 5, wherein calculating the first image hash of the first still image and calculating the second image hash of the second still image each comprise calculating the hash further determined from at least one of image average analysis, perceptual analysis, difference analysis or wavelet analysis on structures within each of the first still image and the second still image.

7. The method of claim 1, further comprising:
creating a first grayscale image of the first still image; and
creating a second grayscale image of the second still image; and
wherein comparing the first still image to the second still image to determine whether the difference is greater than the threshold comprises comparing the first grayscale image to the second grayscale image to determine whether the difference is greater than the threshold.

8. The method of claim 1, wherein the first still image and the second still image are separated by at least one intervening frame of the video presentation.

9. The method of claim 1, wherein:
comparing the first still image to the second still image to determine whether the difference is greater than the threshold further comprises determining a relevant portion of the first still image and a relevant portion of the second still image;
further comparing the relevant portion of the first still image to the relevant portion of the second still image to determine whether the difference is greater than the threshold;
determining the relevant portion of the first still image comprises providing the first still image to a neural network trained to identify relevant portions of images and receiving a decision therefrom; and
comparing the first still image to the second still image to determine whether the difference is greater than the threshold comprises comparing portions of the first still image identified as relevant by the neural network to portions of the second still image identified as relevant by the neural network.

10. The method of claim 9, wherein the neural network is trained comprising:
collecting a set of prior still images from a database, the prior set of still images comprising relevant portions;
applying one or more transformations to each prior still image, including adding a video effect, removing a video effect, adjusting the brightness, adjusting the contrast, inserting a known non-relevant element, removing a known non-relevant element, inserting a known relevant element, removing a known non-relevant element, shifting the location of an element in the image, and resizing an element in the image, to create a modified set of prior still images;
creating a first training set comprising the collected set of prior still images, the modified set of prior still images, and a set of prior still images without a relevant portion;
training the neural network in a first stage using the first training set;
creating a second training set for a second stage of training comprising the first training set and the set of prior still images without a relevant portion incorrectly determined as comprising relevant portions after the first stage of training; and
training the neural network in the second stage using the second training set.

11. A system for compressing a video presentation, comprising:
at processor coupled to a computer memory comprising computer-readable instructions to cause the processor to:
capture a first still image from a first frame of the video presentation;
write the first still image to a document;
capture a second still image from a second frame of the video presentation;
compare the first still image to the second still image to determine whether the difference is greater than a threshold;
when the difference is greater than the threshold, write the second still image to the document and when the difference is not greater than the threshold, omit writing the second still image to the document; and
cause a data storage component to store the document.

12. The system of claim 11, wherein the instructions to cause the processor to compare the first still image to the second still image comprises instructions to cause the processor to:
apply a first mask to mask the first frame to exclude a first human subject image to produce a masked first still image; and
apply a second mask to the second frame to exclude a second human subject image to produce a masked second still image; and
wherein comparing the first still image to the second still image to determine if the difference is greater than the threshold comprises comparing the masked first still image to the masked second still image to determine whether the difference between the first masked image and the second masked image is greater than the threshold.

13. The system of claim 12, further comprising instructions to cause the processor to, upon determining the ratio of the second mask to the second still image is greater than a mask threshold, determine the difference between the masked first still image and the masked second still image is not greater than the threshold.

14. The system of claim 12, wherein:
applying the first mask to mask the first frame to exclude the first human subject image to produce the masked first still image further comprises applying the first mask to a first rectangle selected to minimally include the first human subject image and wherein the first rectangle is at a first location within the first frame; and
applying the second mask to mask the second frame to exclude the second human subject image to produce the masked second still image further comprises applying the second mask to a second rectangle selected to minimally include the second human subject image and wherein the second rectangle is at a second location within the first frame.

15. The system of claim 11, further comprising instructions to cause the processor to:
calculate a first image hash of the first still image; and
calculate a second image hash of the second still image; and
wherein comparing the first still image to the second still image to determine whether the difference is greater than the threshold comprises comparing the first image hash to the second image hash to determine whether the difference is greater than the threshold.

16. The system of claim 15, wherein calculating the first image hash of the first still image and calculating the second image hash of the second still image each comprise a hashing calculation further determined from at least one of image average analysis, perceptual analysis, difference analysis, or wavelet analysis on structures within each of the first still image and the second still image.

17. The system of claim 11, further comprising instructions to cause the processor to:
create a first grayscale image of the first still image; and
create a second grayscale image of the second still image; and
wherein comparing the first still image to the second still image to determine whether the difference is greater than the threshold comprises comparing the first grayscale image to the second grayscale image to determine whether the difference is greater than the threshold.

18. The system of claim 11, wherein:
instructions to cause the processor to compare the first still image to the second still image to determine whether the difference is greater than the threshold further comprise instructions to cause the processor to determine a relevant portion of the first still image and a relevant portion of the second still image;
the instructions further cause the processor to compare the relevant portion of the first still image to the relevant portion of the second still image to determine whether the difference is greater than the threshold;
the instructions further cause the processor to determine the relevant portion of the first still image comprise providing the first still image to a neural network trained to identify relevant portions of images and receive a decision therefrom; and
the instructions to cause the processor to compare the first still image to the second still image to determine whether the difference is greater than the threshold comprises instructions to cause the processor to compare portions of the first still image identified as relevant by the neural network to portions of the second still image identified as relevant by the neural network.

19. The system of claim 18, wherein the neural network is trained comprising:
collecting a set of prior still images from a database, the prior still images comprising relevant portions;
applying one or more transformations to each prior still image, including adding a video effect, removing a video effect, adjusting the brightness, adjusting the contrast, inserting a known non-relevant element, removing a known non-relevant element, inserting a known relevant element, removing a known non-relevant element, shifting the location of an element in the image, and resizing an element in the image, to create a modified set of prior still images;
creating a first training set comprising the collected set of prior still images, the modified set of prior still images, and a set of prior still images without a relevant portion;
training the neural network in a first stage using the first training set;
creating a second training set for a second stage of training comprising the first training set and the set of prior still images without a relevant portion incorrectly determined as comprising relevant portions after the first stage of training; and
training the neural network in the second stage using the second training set.

20. A non-transitory computer-readable medium comprising instructions that, when read by a machine, cause the machine to perform:
capturing a first still image from a first frame of a video presentation;
capturing a second still image from a second frame of the video presentation;
comparing the first still image to the second still image to determine whether the difference is greater than a threshold; and
when the difference is greater than the threshold, writing the second still image to a document, and when the difference is not greater than the threshold, omit writing the second still image to the document.
